(19) United States
(12) Patent Application Publication
(10) Pub. No.: US 2007/0151653 A1
(43) Pub. Date: Jul. 5, 2007

(54) Manufacturing method of rubber member for tire

(75) Inventors: Yojiro Miki, Kobe-shi (JP); Shuichi Yamamori, Kobe-shi (JP)

Correspondence Address: BIRCH STEWART KOLASCH & BIRCH, PO BOX 747, FALLS CHURCH, VA, 22040-0747, US

(73) Assignee: Sumitomo Rubber Industries, Ltd.

(21) Appl. No.: 11/646,297

(22) Filed: Dec. 28, 2006

(30) Foreign Application Priority Data
Dec. 29, 2005 (JP) 2005-380591

(51) Int. Cl. B29D 30/08

(52) U.S. Cl. 156/117; 156/130

(57) ABSTRACT

In a strip wind construction method, the invention provides a manufacturing method of a rubber member for a tire which can reduce an air remnant in a rubber member. A rubber member has an inside first layer formed by spirally winding a rubber strip from a starting point corresponding to any one of reference positions of a center position of a wound body and a side edge to the other reference position in an axial direction in a half region between the center position and an outer edge in a tire axial direction of a winding region, and a second layer formed by folding back from a starting point corresponding to the other reference position to the other in an axial direction, and the reference position corresponding to the starting pint is set to a line-symmetrical position around the center position.

### BACKGROUND OF THE INVENTION

1. Field of the Invention

The present invention relates to a strip wind construction method of forming a rubber member for a tire by spirally winding a rubber strip, and more particularly to a manufacturing method of a rubber member for a tire which can reduce a air remnant in the rubber member.

2. Description of the Related Art

There has been considered to form a rubber member in each of positions of tire, such as a tread rubber, a side wall rubber or the like by spirally winding a rubber strip made of a material corresponding to a demand characteristic of the rubber member. By the strip wind construction method, a mouth piece of a nozzle and a labor hour of a management can be reduced in comparison with an conventional extrusion molding method of continuously extruding from a mouth piece in a predetermined finish cross sectional shape. Further, it is possible to use a compact rubber extruding machine, and it is possible to achieve a large item small scale production. As mentioned above, the strip wind construction method (STW method) can improve a productivity.

However, in the STW method mentioned above, since the rubber strip is spirally wound, an air reservoir tends to be generated due to a step in a side edge of the rubber strip or the like. This is because the adjacent rubber strips are wound astride the step in the side edge of the previously wound rubber strip. There is an increased risk that the air reservoir is generated between a wound body such as a drum or the like, and a rubber layer spirally wound in an outer side in a radial direction thereof, or between the inner and outer rubber layers in the radial direction in comparison with the conventional one mouth method. Accordingly, Japanese Published patent application 2000-254980 proposes a rubber strip provided with thin lug portions in both side edges, in a rubber strip.

In the proposed structure mentioned above, since both the side edges are provided with the thin step, in the case of forming a diagonal side edge portion, a thickness of an edge step is reduced in comparison with a thickness of a base portion. And an error in an outer peripheral edge between a finish cross sectional shape and an outline shape is reduced. Further, it is possible to achieve an effect to reduce a winding number by the thick base portion. However, it becomes necessary to hold specialized mouth pieces for the extruding machine, and a productivity tends to be lowered.

On the other hand, in the STW method, it is necessary to expel the air between the layers so as to prevent the air reservoir from being generated. Accordingly, a degree of adhesion is increased by pressing a roller to the spirally wound rubber layer or a previously wound rubber layer. Therefore, there is employed a straight bar-shaped pressing roller RT having a length more than a length of the rubber member to be formed or a half length, for example, as shown in FIG. 9. The pressing roller RT moves close to and away from a wound body P while keeping a parallel state.

However, there is a case to form a tread rubber having bulge portions a protruding to an outer side in a radial direction in both side shoulder portions, for example, as shown in FIG. 8, by the STW method. In the case that a rubber strip T is spirally wound from a leading position e1 to a trailing position e2 as shown in FIG. 9, a thickness is increased comparatively rapidly in the winding start position e1 side for forming a buttress portion 2B of a tread rubber G1. At this time, a height Hr of the pressing roller RT is increased following to it. After the pressing roller RT comes to a highest position in the radial direction at a peak point HrM corresponding to a apex ap of the bulge portion a, it is impossible to follow the reduction of the thickness of the rubber member G. It is hard to press the outer surface of the rubber member G thereafter. In other words, the subsequent pressing is interrupted at the apex ap of the first bulge portion a. Therefore, it is hard to form the rubber member G having a good precision with no air reservoir, and a high degree of adhesion between the rubber strips. The pressing roller RT actually moving only close to or away from (moving in a radial direction) is illustrated by being shifted in an axial direction for clearly showing an operating state, in the drawings attached to the specification of the present invention.

Further, FIG. 10 shows a case that a tread rubber G1 constituted by one rubber layer is formed by spirally winding a rubber strips T and T in both sides from a center position of a wound body such as a former or the like. A roller height Hr of the pressing roller RT is increased little by little in a small thickness portion of a center region and portions having a gradually increased thickness in both sides, and it is possible to efficiently press the rubber member G. Admitting that, since the pressing roller RT can not move down over the roller height HrM in a shoulder region which gets over the apex ap (the roller height HrM) of the bulge portions a in both sides outside in a tire axial direction, a pressing effect is inferior to the pressing operation of the shoulder portion.

### BRIEF SUMMARY OF THE INVENTION

As a result of making a study of the formation of the rubber member with a high precision and with no air reservoir in accordance with the STW method, there is conceived that it is preferable to execute a pressing as uniform as possible and set the thickness about a half height of each of the rubber members G without making the thickness too large, in order to obtain a preferable rubber member. Accordingly, it is possible to effectively transmit the pressing force by the pressing roller RT to an entire thickness of each of the layers. Further, there is conceived that it is preferable to spirally wind an entire length by dividing in a length direction in place of continuously winding the entire length in the tire axial direction.

Accordingly, an object of the present invention is to provide a manufacturing method of a rubber member for a tire which can reduce an air reservoir and can improve a junction between the rubber strip even in the case of using a rubber strip having a rectangular cross section in an STW method.

In accordance with the present invention, there is provided a manufacturing method of a rubber member for a tire constituted by a plurality of rubber layers overlapping in inner and outer sides in a radial direction, by spirally winding a ribbon-shaped unvulcanized rubber strip around a cylindrical wound body while moving in an axial direction, wherein the rubber member includes an inner first layer and a second layer. The first layer is formed by spirally winding the rubber strip from a starting point corresponding to a reference position of any one of a center position of the wound body and a side edge to the other reference position in an axial direction, in a half region between the center position and an side edge in a tire axial direction of a winding region. And the second layer is formed by folding back from the other reference position corresponding to the starting point of the first layer. The reference positions are set at a line-symmetrical position with respect to the center position.

A compounded rubber of a plurality of rubber layers can be identical. The structure can be made such that the first layer is wound from the reference point that is the starting point corresponding to the outer edge in the tire axial direction in the winding region to the reference point that is the center position, and the second layer is formed by being folded back at the center position so as to be wound to the outer edge in the tire axial direction. Further, the structure can be made such that the rubber member is a tread rubber, the first layer is constituted by a rubber layer having a flat thickness, and second layer is spirally wound in such a shape as to apply a similar thickness change to a shape of the tread rubber member in a green tire.

The rubber strip can be pressed by using a pressing roller which is movable close to and away from the wound body in parallel and is in a long straight rod shape having a uniform diameter, at a time of winding.

As mentioned above, in the present invention, in the STW method, the rubber strip is symmetrically reciprocated in the half region between the center position of the wound body and the outer edge in the tire axial direction of the wound body. Accordingly, the first layer and the second layer are formed in the inner and outer sides. Therefore, even in the case of using the pressing roller above described, it is easy to press as an approximately line-symmetrical shape at the center position. Accordingly, it is possible to obtain the rubber member which is good in a shape balance. Further, since the rubber member comprises the first and second layer, the first layer in the inner side in the radial direction can be efficiently pressed over an entire thickness. It is possible to suppress generation of an air reservoir on the basis of an air vent. Further, it is possible to improve an adhesion between the rubber strips, and is possible to mold the rubber member which is good in a uniformity, a durability and a dimensional precision.

Since the rubber strip is pressed in the long straight rod shape having the uniform diameter and by using the pressing roller RT which is movable close to or away from the wound body in parallel, it is possible to make a surface shape of the rubber member after being spirally wound smoother in comparison with the case of being pressed by a thin disc shaped roller, and it is possible to improve a quality of the rubber member by uniformizing the press-down force.

### BRIEF DESCRIPTION OF THE SEVERAL VIEWS OF THE DRAWINGS

FIG. 1 is a cross sectional view of a tire showing an embodiment in accordance with the present invention;

FIG. 2 is a cross sectional view of a rubber member exemplifying a first layer and a second layer in the case that the rubber member in accordance with the present invention is a tread rubber;

FIG. 3 is a cross sectional view exemplifying only the first layer in the case shown in FIG. 2;

FIG. 4A is a perspective view exemplifying a forming apparatus;

FIG. 4B is a perspective view exemplifying a rubber strip;

FIG. 5 is a cross sectional view exemplifying the other embodiment forming a rubber member;

FIG. 6 is a cross sectional view exemplifying only the first layer in the case shown in FIG. 5;

FIG. 7 is a cross sectional view exemplifying further the other embodiment;

FIG. 8 is a cross sectional view exemplifying a cross section of a tread rubber in accordance with a conventional extrusion;

FIG. 9 is a cross sectional view exemplifying a case that a tread rubber is formed by a conventional one-layer winding; and

FIG. 10 is a cross sectional view exemplifying a case that a tread rubber is manufactured by one-layer winding toward both sides from a starting point corresponding to a center position of the rubber member.

### DETAILED DESCRIPTION OF THE INVENTION

A description will be given of an embodiment in accordance with the present invention with reference to the accompanying drawings.

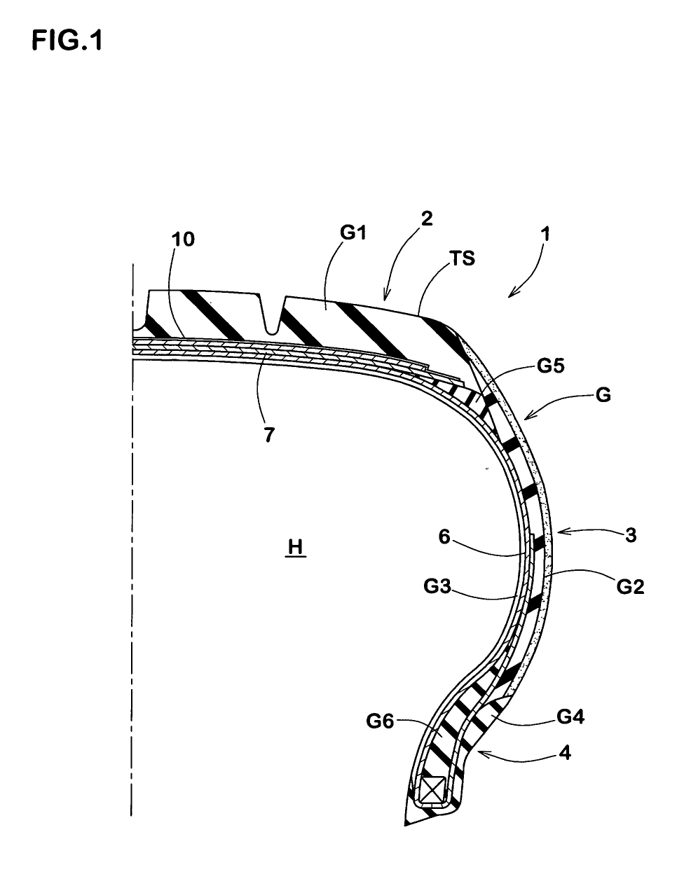

FIG. 1 exemplifies a case that a pneumatic tire is constituted by a radial tire for a passenger car. A tire 1 is provided with plural kinds of tire rubber members G, for example, a tread rubber G1 arranged in a tread portion 2 and forming a ground surface. The tread rubber G1 is formed approximately line-symmetrically in an axial direction around a tire equator. A description will be given of an example of a manufacturing method in accordance with the present invention by exemplifying a case of being used for forming the tread rubber G1.

However, the present invention can be adopted to a side wall rubber G2 arranged in a side wall portion 3 and forming a tire outer surface, an inner liner rubber G3 arranged in an inner side of a carcass 6 and surrounding a tire inner cavity H, a clinch rubber G4 arranged in a bead portion 4 and preventing a rim displacement, a belt cushion rubber G5 arranged in both ends of a belt 7 and between the both ends and the carcass 6 and protecting an outer end of the belt, and the like. Further, it is possible to include a bead apex rubber G6 extending to an outer side in a radial direction from a bead core 5 of the bead portion 4 as the rubber member G. In this case, in the present embodiment, a band 10 is arranged in an upper surface in a radial direction of the belt 7. The band 10 is formed by spirally winding a band-like ply formed by embedding a plurality of cords in a topping rubber, for example, around an entire surface of an outer periphery of the belt 7, and preferably at a uniform thickness. Accordingly, it is possible to prevent the belt 7 from lifting up, and a tread reinforcing layer is structured in cooperation with the belt 7.

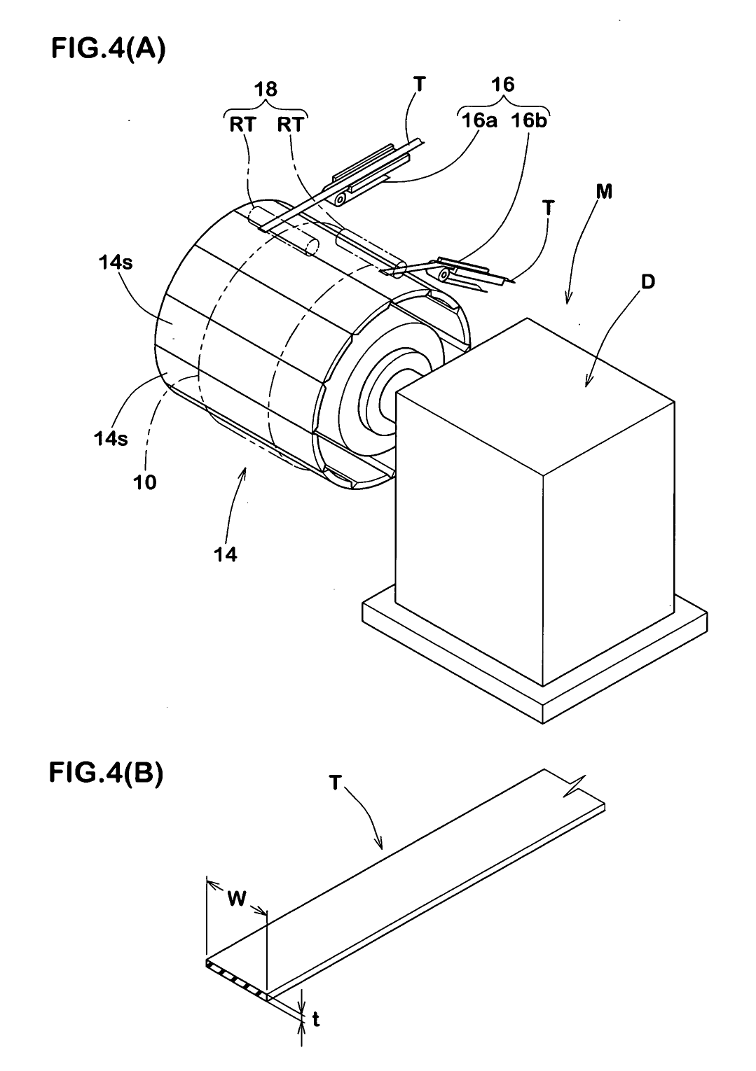

FIG. 4A exemplifies a forming apparatus M which can be used for a manufacturing method in accordance with the present invention. The forming apparatus M is provided with a base table D, a cylindrical forming former 14 rotatably supported to the base table D, and a strip delivery apparatus 16 capable of supplying the rubber strip T to the former 14, for example, constituted by first and second applicators 16a and 16b. Further, the forming apparatus M includes a pressing apparatus 18 constituted by long rod-shaped first and second pressing rollers RT and RT extending in an axial direction of the former 14. In the former 14, a plurality of segments 14s construct an outer peripheral surface 14A. Further, the segments 14s can move forward and backward in a tire radial direction by an expansion and contraction mechanism (not shown)in an inner portion so as to be capable of the expanding and contracting. It is possible to detach the wound rubber member G in accordance with the contraction.

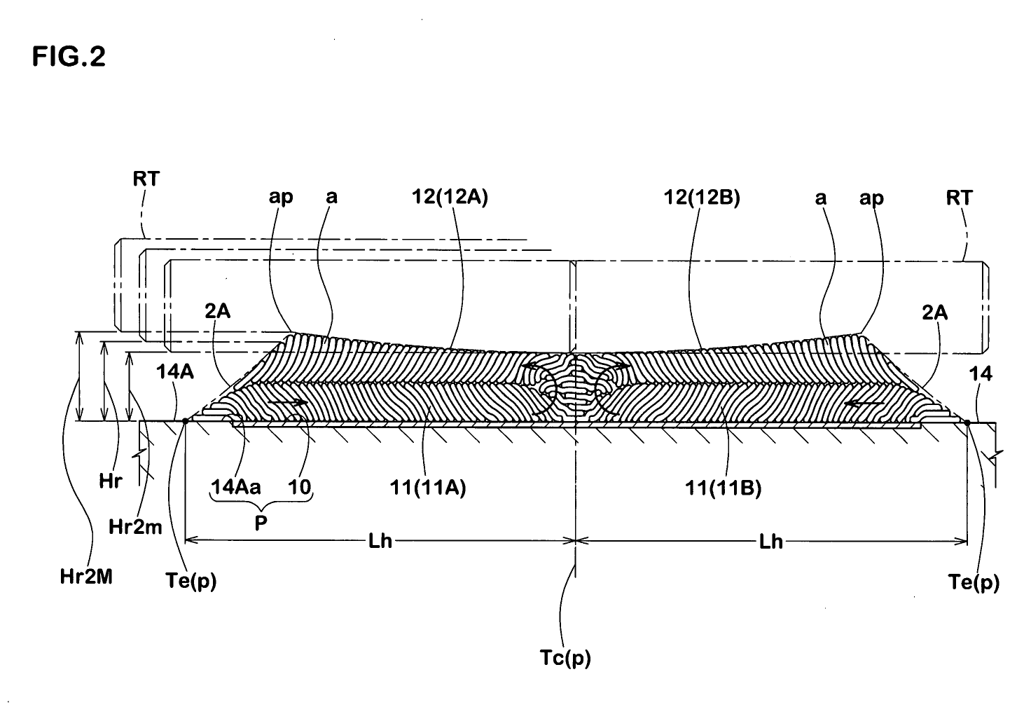

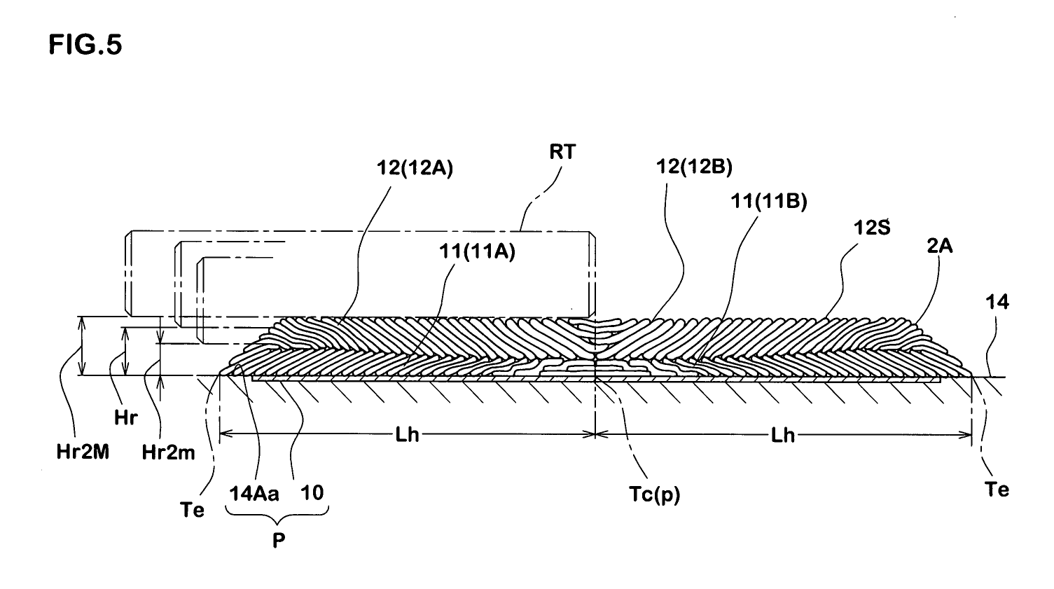

Further, in the present embodiment, the wound body P (shown in FIGS. 2 and 5) around which the rubber strip T forming the tread rubber G1 is wound is constituted by the band 10 wound around an outer peripheral surface 14A of the former 14, and a protruding portion 14Aa of the former 14 protruding from the band 10.

In this case, the band 10 is preferably fitted to a concavity provided in the outer peripheral surface 14A of the former 14. Accordingly, the band 10 becomes flush with the outer peripheral surface 14A corresponding to the protruding portion 14Aa. Further, a surface-finish is applied to the protruding portion 14Aa for increasing an adhesion property with the rubber strip T and preventing a displacement of a winding start end so as to smoothen a winding work.

The pressing roller RT is formed in a straight rod shape of a uniform diameter at a length of a half or more than a half of the wound body P, in the present embodiment. Further, facing inner ends of the respective pressing rollers RT are arranged at a center position Tc of the wound body P so as to be coincided in a circumferential direction. Further, the pressing roller RT constitutes a part of a pressing apparatus (not shown) which controls an actuation of the pressing roller RT. The pressing roller RT moves close to and away from the former 14 while keeping a parallel state to the former 14 and without moving in an axial direction. It is possible to align thicknesses of the wound rubber members G by the close moving, the air vent is achieved by the pressing, and it is possible to preferably press the rubber strip T uniformly so as to connect each other. In this case, the pressing roller RT is positioned in a downstream side of each of the applicators 16a,16b and can press the rubber member G formed by winding the rubber strip T fed from the applicators 16a, 16b.

The rubber strip T is formed in a ribbon shape made of an unvulcanized rubber as exemplified in FIG. 4B. The rubber strip T is structured such that a thickness t is between 0.3 and 3.0 mm, preferably a width W is between 5 and 50 mm. In the case that the width W is less than 5 mm, or in the case that the thickness t is less than 0.3 mm, a lot of winding number is necessary at a time of finishing a predetermined tread cross sectional shape, and a productivity is lowered. On the contrary, in the case that the width W is more than 50 mm or in the case that the thickness t is more than 3.0 mm, there is a tendency that it is hard to form a delicate cross sectional shape of the tread rubber.

Further, taking into consideration factors such as a low heat generation property, a grip performance, an abrasion resistance service life and the like as the tread rubber G1, a rubber composition, JISA hardness, a complex elastic modulus (E*) and a tangent of the loss angle (tan δ) are selected in an optimum manner. In this case, a silica can be employed as a rubber filler in addition to the carbon black. The silica compounded rubber in which the silica is compounded can improve a wet grip performance, and can reduce a rolling resistance on a dry road surface. However, an electric resistance is increased. Accordingly, in order to suppress the increase of the electric resistance, it is preferable to set a conductive coat on the rubber strip T, for example, at least one surface thereof so as to make a rim conductive from a tread ground surface TS.

A half region Lh is defined as a portion between a center position Tc of the wound body P, and one outer edge Te in the tire axial direction of a winding region around which the rubber strip T is wound (a forming region of the winding body). Further, the center position Tc or each of the outer edges Te is defined as reference positions p and p. Actually, “center position Tc” and “outer edge Te” include “vicinity” allowing a length in the tire axial direction equal to or less than about 5% of the half region, from each of the positions, in this specification.

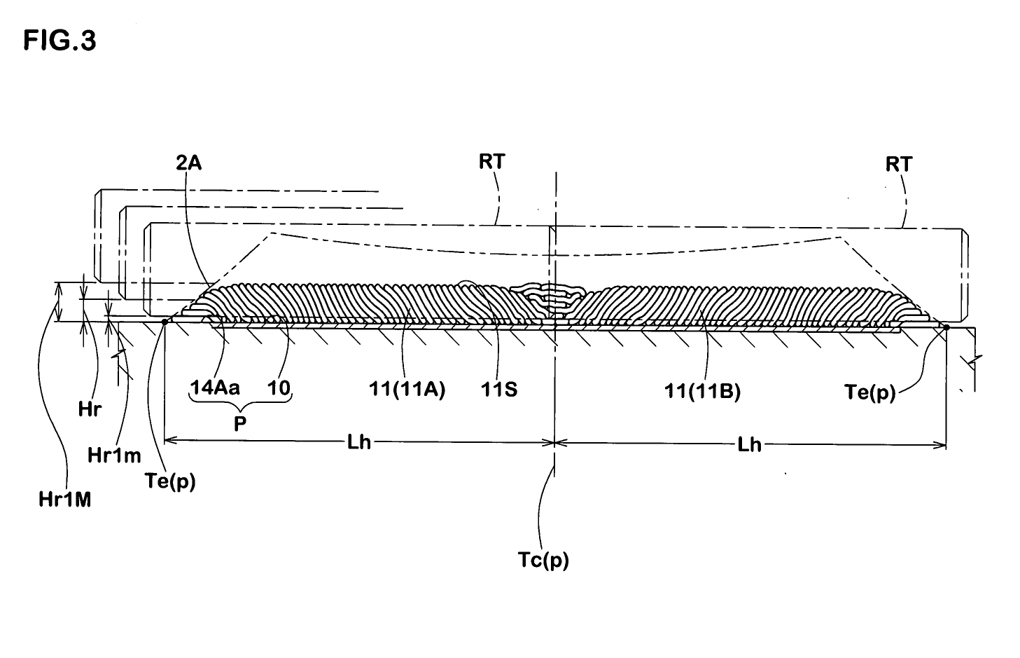

In the present invention, the tread rubber G1 is structured such that the rubber strip T is spirally wound from a starting point corresponding to one of the reference positions p and p constituted by the center position Tc or the outer edge Te, to the other reference position p (the outer edge Te or the center position Tc) in the axial direction, as shown in FIG. 3. An inner first layer 11 is formed by winding in the axial direction. The center position Tc of the “wound body 14” means the center position of the “winding region” where the tread rubber G1 is formed.

Next, a second layer 12 is formed by folding back from the starting point of the corresponding to each of the other reference positions(the starting position of the first layer 11) to the other in the axial direction.

Further, a description will be given of a case shown in FIGS. 2 and 3. It is wound inward in the axial direction from the starting point corresponding to the reference point p of the outer edge Te to the reference point p of the center position Tc. A first layer 11A in one of the half regions Lh, and a first layer 11B (called as a first layer 11 in conjunction) in the other are formed in both sides of the center position Tc, by respectively setting the outer edges Te in both sides to the starting points. The first layer 11A and the other first layer 11B are approximately line-symmetrical around the center position Tc. In this case, the respective first layers 11 in both sides are folded back at the center position Tc. Near the center position Tc, there tends to be generated a portion where the rubber strips T of the first layer 11 and the second layer 12 intersect, that is, a portion where the winding is asymmetrically and turbulent. In the present invention, the winding including the turbulent portion is called as “approximately line-symmetrical” or “line-symmetrical”.

Further, each of the first layers 11 in both sides is formed in a flat shape in which a rubber height is almost constant in an upper surface 11S. Accordingly, the roller height Hr of the pressing roller RT, which is minimum value Hr1m in the starting point, is increased in accordance with forming the outer surface of the buttress portion 2A (the upper side of the side wall portion 2). After that, the pressing roller RT can press the rubber strip continuously wound while keeping the state of a rubber height Hr1M of the first layer 11. The first layer 11 of the rubber height Hr1M becomes approximately line-symmetrical around the center position Tc. Even when the upper surface 11S is swell (expanding shape) in which the rubber height Ht is increased toward the center position Tc, the pressing roller RT can follow.

Further, the second layers 12A and 12B (called as the second layer 12 in conjunction) are formed on the first layers 11A and 11B folding back the rubber strip T at the center position Tc toward the other reference point p, that is, the outer edge Te after forming the turbulent and asymmetrical portion in which the rubber strips T overlap, as mentioned above, at the fold-back portion. The second layer 12 is relatively thin in the center region, and the height is increased little by little toward the outer edge Te. Accordingly, there is formed the bulge portion a in which the upper surface 12S bulges gradually to each of the shoulder portion side, and there is formed a concave shape in which the center region is depressed.

Accordingly, in the pressing roller RT mentioned above, the starting point in the second layer 12 exists in the center position Tc, as shown in FIG. 2. The rubber thickness of the portion is minimum in the second layer 12. Therefore, the roller height Hr comes to the minimum value Hr2m. After this state is continued, the height Hr of the pressing roller RT is increased in the bulge portion a together with the increase of the rubber thickness. The apex ap of the bulge portion a comes to the maximum height Hr2M. After passing through the apex ap, it comes to a buttress portion 2A of the second layer 12 which can not be pressed by the pressing roller RT, since the pressing roller RT can not move down. Because the portion 2A is small, it is possible to be left for pressing at a time of forming a metal mold, or it is possible to press by independently using a press roller (not shown) having a small width.

As mentioned above, the first layer 11 has a half thickness and a pressing effect is larger, in comparison with the structure in which the entire thickness is formed by one spiral winding. Accordingly, it is possible to properly bond the rubber strips T to each other. Also, it is possible to uniformly press in the entire length, and it is possible to reduced the air reservoir. Further, the second layer 12 has a half thickness of the conventional single layer tread rubber G, it is possible to efficiently extrude the air and connect between the rubber strips T by pressing.

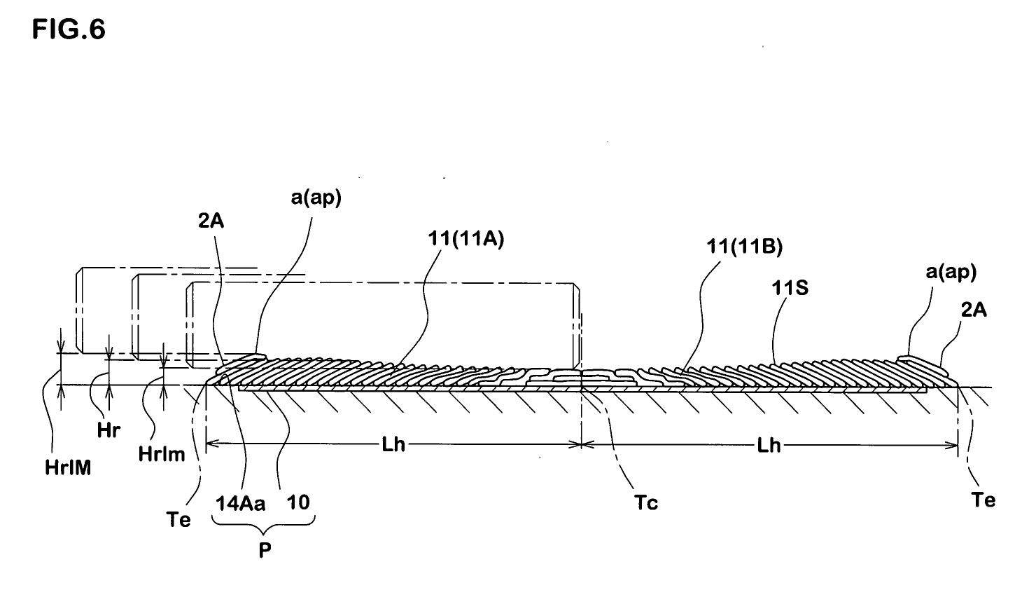

FIGS. 5 and 6 exemplify the other embodiment of spirally winding from the starting point corresponding to the center position Tc toward each of the outer edges Te. In the present embodiment, the first layer 11 (including the first layer 11A and the first layer 11B) of each of the half lengths Lh is formed by spirally winding from the starting point corresponding to the center position Tc toward each of the outer edges Te. Further, the second layer 12 (including the second layer 12A and the second layer 12B) of each of the half lengths Lh is formed by folding back at each of the outer edges Te toward the center position Tc.

In this embodiment, the upper surface 11S in each of the first layers 11 in both sides is structured such that a rubber height is a minimum height Hr1m at the center position Tc forming the starting point, and the rubber height is gradually increased toward the outer edge Te. Accordingly, it is formed as a concave shape in which the bulge portion a near the outer edge Te comes to the maximum height H1rM. The height Hr of the pressing roller RT is increased from the state of the minimum roller height Hr1m toward the outer edge Te in accordance with the outer surface of the bulge portion a, as shown in FIG. 6. of Further, it comes to the rubber maximum height H1rm of the first layer 11 at the apex ap of the bulge portion a. In this case, the outer surface of the buttress portion 2A getting over the apex ap to the outer side in the tire axial direction is pressed by an after treatment as occasion demands.

As described above, the pressing roller RT can press the rubber strip T at a time of the winding in which the upper surface 11S is formed in the concave shape, and the entire shape is approximately line-symmetrical around the center position Tc. In the case of the upper surface 11S being flat, the pressing roller RT can easily press the winding body in the entire length range.

The second layers 12A and 12B (called as the second layer 12 in conjunction) are formed on the first layers 11A and 11B by being folded back at the outer edge Te. The second layer 12 is folded back toward the reference point p of the center position Tc. The second layer 12 is made relatively thicker in the center region between the buttress 2A and 2A, so as to compensate the structure in which the upper surface 11S of the first layer 11 is formed concave. Accordingly, the pressing roller RT is maintained at the roll height Hr2M of the upper surface 12S of the second layer 12. Therefore, the entire rubber thickness comes to the uniform thickness over the entire of the half length Lh, that is, the upper surface 12S of the second layer 12 is formed flat.

The pressing roller RT exists at the maximum roller height Hr1M of the first layer 11 at the starting point (the winding start) of the second layer 12, as shown in FIG. 5. Together with the winding, the roller height Hr is increased along the buttress portion 2A. Thereafter, it is held at the roller height Hr2M continuously pressing the upper surface 12S of the second layer 12. Since the rubber member G is divided into the first layer 11 and second layer 12 which are pressed individually, it is possible to uniformly press and is possible to form the tread rubber G1 having substantially no air reservoir and being good in the bonding degree of the rubber strip T.

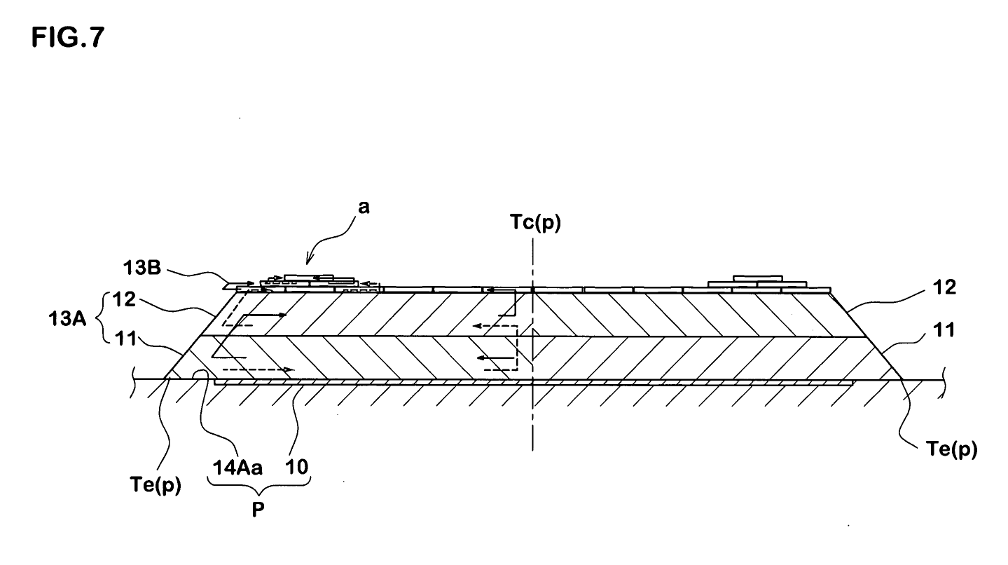

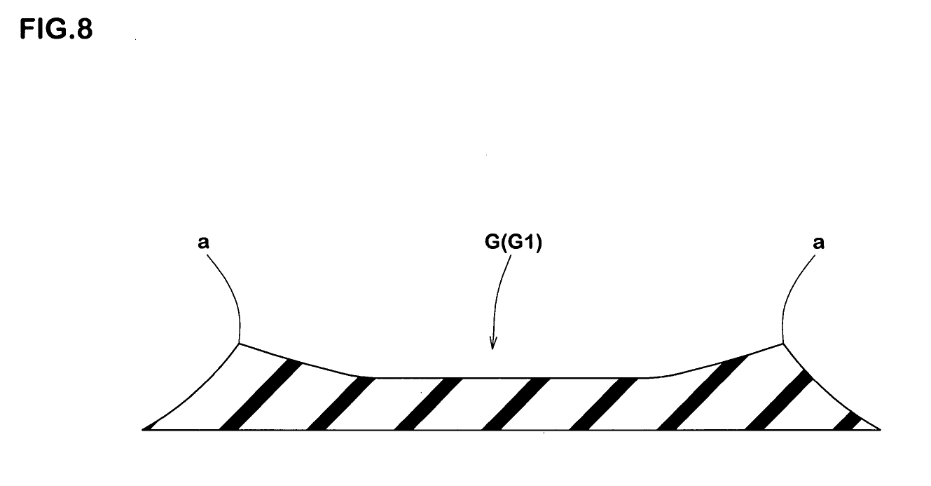

FIG. 7 shows further the other embodiment. In the embodiment, a bulge portion a of a shoulder portion is formed by setting an additional layer 13B forming the bulge portion a of the shoulder portion, in addition to a base portion 13A constituted by the first layer 11 and the second layer 12.

The base portion 13A is formed on the basis of each of the embodiments mentioned above. In FIG. 7, the first layer 11 is wound from the starting point corresponding to the center position Tc are shown by a solid line arrow. At this time, it reaches the center position Tc after being folded back at the outer edge Te. Further, it is possible to form the additional layer 13B forming the bulge portion a of the shoulder portion by folding back to the outer edge Te, for example, by one layer thickness, and thereafter repeating at a plurality of times.

Further, the case that the starting point of the first layer 11 is set to the outer edge Te is shown by a broken arrow. At this time, it reaches the outer edge Te of the second layer 12 after being folded back at the center position Tc, and the base portion 13A is constituted. Further, the additional layer 13B forming the bulge portion a of the shoulder portion is formed by folding back at the outer edge Te, for example, by one layer thickness and may be thereafter repeated at a plurality of times.

As mentioned above, in the case shown in FIG. 7, it is possible to uniformly press each of the first layer 11, the second layer 12 and the additional layer 13B by the pressing roller RT (except a part of the buttress portion 2A). Accordingly, it is possible to form the tread rubber G1. As mentioned above, in the case shown in FIGS. 2, 3, 5, 6 and 7, it is possible to execute the uniform pressing by using the pressing roller RT. Further, it is possible to make the outer surface smooth, and it is possible to form the tread rubber G1 having no air reservoir. In this case, it is possible to manufacture the other various rubber members than the tread rubber G1.

The description is given above of the embodiments in accordance with the present invention, however, the present invention can be applied to the other rubber strips having the other cross sectional shapes than the rectangular shape in correspondence to the performance demanded for the tire. Further, various materials can be employed as the rubber strip. The present invention is particularly preferable for the pneumatic tire for the passenger car, however, it goes without saying that the present invention can be applied to various tires such as tires for a motor cycle, a truck, a bus and the like, in addition to the tire for the passenger car.

### EXAMPLES

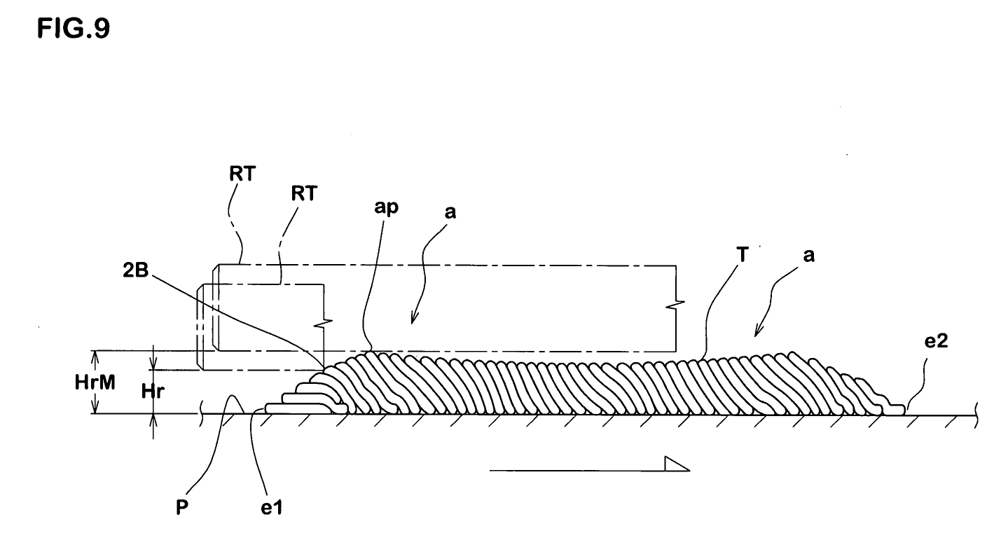

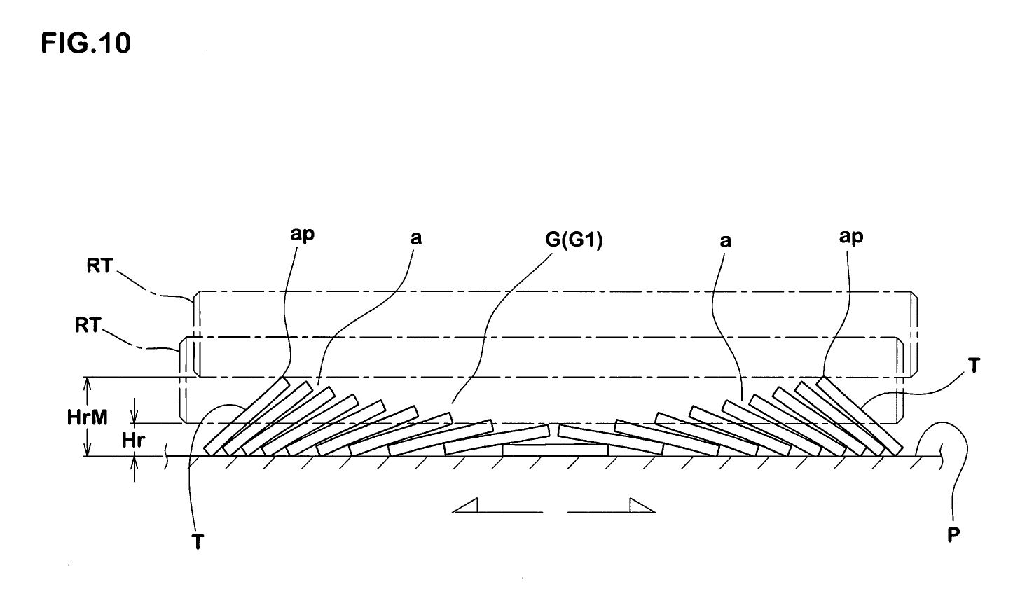

There is manufactured a tread rubber G1 of a pneumatic radial tire for a passenger car on the basis of a tire size of 215/45ZR17 and a specification shown in Table 1. A test is executed about a performance thereof. In this case, a rubber strip is set to be identical. Results thereof are shown in Table 1. In the tested specification, FIGS. 2 and 3 are set to an example 1, FIGS. 5 and 6 are set to an example 2, FIG. 9 is set to a comparative example 1, and FIG. 10 is set to a comparative example 2.

TABLE 1

| | Example | Example | Comparative | Comparative |
|---|---|---|---|---|
| | 1 | 2 | Example 1 | Example 2 |
| Specification | | | | |
| | and 3 | and 6 | | |
| Rubber strip | 15 × 1 | 15 × 1 | 30 × 1 | 30 × 1 |
| width × thick- | | | | |
| ness (mm) | | | | |
| Uniformity | 52 | 53 | 59 | 57 |
| RFV (N) | | | | |

Twenty tires are manufactured for each of the tires, and a uniformity is measured. The uniformity is measured as a radial force variation (RFV) on the basis of a uniformity test condition of JASO C607:2000. An evaluated speed is set to 10 km/h. Results are expressed by an average (N) of twenty tires, and the smaller the numerical value is, the better the result is.

What is claimed is:

1. A manufacturing method of a rubber member for a tire constituted by a plurality of rubber layers overlapping in inner and outer sides in a radial direction, by spirally winding a ribbon-shaped unvulcanized rubber strip around a cylindrical wound body while moving in an axial direction, wherein in the case that a region between a center position of said wound body and an outer edge in a tire axial direction of a winding region is defined as a half region, and both of said center position and said outer edge are defined as a reference position, said rubber member includes an inner first layer formed by spirally winding the rubber strip from a starting point corresponding to any one of the reference positions to the other reference position in an axial direction, and a second layer formed by folding back from a starting point corresponding to the other reference position of the first layer to the other in the axial direction, and the reference position corresponding to each of the starting points is positioned line symmetrically around said center position.

2. A manufacturing method of a rubber member for a tire as claimed in claim 1, wherein a compounded rubber of said plurality of rubber layers is identical.

3. A manufacturing method of a rubber member for a tire as claimed in claim 1, wherein said first layer is wound from the starting point corresponding to said outer edge of the winding region to the reference position corresponding to the center position, and the second layer is formed by being folded back at the center position so as to be wound to the reference position corresponding to said outer edge.

4. A manufacturing method of a rubber member for a tire as claimed in claim 1, wherein said rubber member is a tread rubber, the first layer is constituted by a rubber layer having a flat thickness, and the second layer is spirally wound in such a shape as to have a similar thickness change to a shape of the tread rubber member in a green tire.

5. A manufacturing method of a rubber member for a tire as claimed in claim 1, wherein said wound body is constituted by a former in which a band of a tread reinforcing body is wound in an outermost side in a radial direction, and a surface-finish portion attaching a rubber strip leading end to the former is formed on a surface of said former protruding outside from said band in the axial direction.

6. A manufacturing method of a rubber member for a tire as claimed in claim 1, wherein said rubber member is structured such that an additional layer formed on an outermost side in a radial direction forms a bulge portion bulging outward in a radial direction in a shoulder portion of said tread rubber.

7. A manufacturing method of a rubber member for a tire as claimed in claim 1, wherein said rubber strip is pressed in a region capable of being pressed by using a pressing roller having a long straight rod shape having a uniform diameter and capable of moving close to and away from the wound body in parallel, at a time of winding.
